(19) United States
(12) Patent Application Publication
(10) Pub. No.: US 2025/0101652 A1
(43) Pub. Date: Mar. 27, 2025

(54) LAUNDRY TREATING APPARATUS

(71) Applicant: LG ELECTRONICS INC., Seoul (KR)

(72) Inventors: Minkyu SANG, Seoul (KR); Dosu KIM, Seoul (KR); Soonchang HONG, Seoul (KR); Dongyeon KIM, Seoul (KR)

(73) Assignee: LG ELECTRONICS INC., Seoul (KR)

(21) Appl. No.: 18/898,036

(22) Filed: Sep. 26, 2024

(30) Foreign Application Priority Data
Sep. 26, 2023 (KR) 10-2023-0129269

(51) Int. Cl. D06F 34/04; D06F 34/08; D06F 37/04; D06F 37/28

(52) U.S. Cl. CPC D06F 34/04; D06F 34/08; D06F 37/04; D06F 37/28

(57) ABSTRACT

The present disclosure provides a laundry treating apparatus wherein a speaker that is coupled to a cabinet to convert information transmitted from at least one of a controller and a control panel into sound waves is at least partially disposed forward of the cabinet.

This application claims the benefit of Korean Patent Application No. 10-2023-0129269, filed on Sep. 26, 2023, which is hereby incorporated by reference as if fully set forth herein.

### BACKGROUND

### Field

The present disclosure relates to a laundry treating apparatus. More specifically, the present disclosure relates to a laundry treating apparatus in which a front panel is formed as an integral plate.

### Discussion of the Related Art

In general, a laundry treating apparatus is an apparatus that performs at least one of a washing cycle that removes foreign substances from laundry and a drying cycle that removes moisture from the laundry. Such a laundry treating apparatus may be equipped with a screen that may externally display a state of the washing cycle or the drying cycle to a user or externally display contents of a notification occurred in the laundry treating apparatus.

While checking the corresponding screen, the user may select a course that may perform the washing cycle or the drying cycle, or learn a progress state of the washing cycle or the drying cycle and other information displayed on the laundry treating apparatus.

Recently, a laundry treating apparatus that includes not only a display but also a speaker that audibly outputs contents displayed on the display or additional information has appeared.

The corresponding laundry treating apparatus may deliver necessary information even when the user is at a location where the user is not able to check the display and may deliver the information intuitively even when the user does not focus on the display, by audibly delivering the information to the user via the speaker.

In the past, it was common for the laundry treating apparatus to install the speaker inside the cabinet. However, when the speaker is installed inside the cabinet, sound emitted from the speaker collides with an inner wall of the cabinet, resulting in reduced propagation power. In addition, a sound wave emitted from the speaker collides with an inner surface of the cabinet and internal components of the laundry treating apparatus, causing an unnecessary resonance sound, making it difficult to transmit accurate sound information.

To solve such problem, when the speaker is exposed to the outside of the cabinet or is disposed outside the cabinet, durability of the speaker is not guaranteed because the speaker is directly exposed to the laundry, moisture, and external impact.

In addition, the speaker is able to be installed on a door so as to emit the sound toward the cabinet rather than forward of the door to block the speaker from being exposed to the outside. In this case, most of the sound waves emitted from the speaker are transmitted rearward, making it difficult to accurately transmit the sound information to the user located in front of the cabinet.

### SUMMARY

The present disclosure is to provide a laundry treating apparatus in which at least a portion of a speaker is installed on an outer side of a cabinet or exposed to the outside of the cabinet to transmit sound information to a user as it is without interference.

The present disclosure is to provide a laundry treating apparatus in which a speaker may be disposed on a cabinet to face forward.

The present disclosure is to provide a laundry treating apparatus in which a speaker may be prevented from coming into contact with or being exposed to laundry or moisture even when being exposed to the outside of a cabinet.

To solve the above-described problems, the present disclosure provides a laundry treating apparatus including a speaker coupled to a cabinet to convert information transmitted from at least one of a controller and a control panel into sound waves, wherein the speaker is at least partially disposed forward of the cabinet.

The cabinet may include a seating groove extending stepwise from an inner circumferential surface of the opening, wherein the door is seated in the seating groove, and the speaker may be at least partially exposed forward of the seating groove.

The speaker may be disposed in the seating groove to emit the sound waves forward.

The control panel of the laundry treating apparatus may be coupled at a location above the opening, and the speaker may be disposed in an area of the seating groove between the control panel and the opening.

The speaker may be disposed so as to be shielded by the door.

The speaker may be prevented from being exposed to the outside when the door closes the opening.

The seating groove may further include an installation hole formed in an area above a hinge fixing the door that opens and closes the opening, wherein the speaker is installed in the installation hole or exposed via the installation hole.

The installation hole may have an area size greater than an area size of the speaker.

The laundry treating apparatus of the present disclosure may further include an installation panel coupled to an inner surface of the cabinet at a location above the opening, and a speaker mounting portion extending from the installation panel to be exposed to the installation hole and fixing the speaker.

The speaker mounting portion may include an exposed plate inserted into the installation hole and exposed to the seating groove, and a guide hole extending through the exposed plate such that a cable connecting the speaker with the control panel or the controller passes therethrough.

The speaker may include a main body seated on the exposed plate, a sound generator accommodated in the main body and connected to the cable to generate the sound waves, a main body coupling portion extending from the main body and coupled to the exposed plate, and a buffer member disposed between the main body coupling portion and the exposed plate to buffer vibration or impact.

The main body may be disposed to be spaced apart from the exposed plate.

The speaker mounting portion may further include a coupling protrusion protruding forward from the exposed plate and coupled with the main body coupling portion or the buffer member.

The coupling protrusion may include a deviation preventing portion having a diameter greater than a diameter of a fixing end to prevent deviation of the main body coupling portion or the buffer member.

The laundry treating apparatus of the present disclosure may further include a hot air supply portion that is coupled onto the tub and supplies hot air into the drum.

The present disclosure may transmit the sound information to the user as it is without the interference as at least the portion of the speaker is installed on the outer side of the cabinet or exposed to the outside of the cabinet.

The present disclosure may guarantee straight transmission of the sound information as the speaker is disposed on the cabinet to face forward.

The present disclosure may prevent the speaker from coming into contact with or being exposed to the laundry or moisture even when the speaker is exposed to the outside of the cabinet.

### BRIEF DESCRIPTION OF THE DRAWINGS

FIG. 1 shows an outer appearance of a laundry treating apparatus of the present disclosure.

FIG. 2 shows an internal cross-section when a laundry treating apparatus of the present disclosure is equipped as a composite apparatus.

FIG. 3 shows an internal structure of a cabinet of a laundry treating apparatus of the present disclosure in detail.

FIG. 4 shows a structural embodiment of the control panel 100 of the laundry treating apparatus of the present disclosure.

FIG. 5 shows an outer appearance of an auxiliary apparatus that may be included in a laundry treating apparatus of the present disclosure.

FIG. 6 shows an internal structural embodiment when a laundry treating apparatus of the present disclosure is equipped as an auxiliary apparatus.

FIG. 7 shows a structural embodiment of a front panel of a laundry treating apparatus of the present disclosure.

FIG. 8 shows a method for manufacturing a corner of the front panel.

FIG. 9 shows an upper portion of a cabinet in a state in which the control panel is coupled.

FIG. 10 shows a method of coupling the front panel with the control panel.

FIG. 11 shows a process of installing the control panel on the front panel.

FIG. 12 shows an embodiment of a coupling fixer that couples a display panel to an installation panel.

FIG. 13 shows an embodiment of a coupling fixer that couples a cover panel to an installation panel.

FIG. 14 shows an embodiment in which a laundry treating apparatus of the present disclosure installs a speaker.

FIG. 15 shows an embodiment in which the speaker is installed on a front panel.

FIG. 16 shows a speaker mounting portion as viewed from the rear of a front panel.

FIG. 17 shows a speaker mounting portion as viewed from the front of a front panel.

FIG. 18 shows a structural embodiment in which the speaker is coupled to the speaker mounting portion.

FIG. 19 shows a cross-section in which a speaker is coupled to a speaker mounting portion.

### DESCRIPTION OF SPECIFIC EMBODIMENTS

Hereinafter, embodiments disclosed herein will be described in detail with reference to the attached drawings. In the present document, identical or similar components are assigned identical or similar reference numerals even in different embodiments, and descriptions thereof are replaced with the first description. A singular expression used herein includes a plural expression unless the context clearly indicates otherwise. In addition, when describing the embodiments disclosed herein, when it is determined that a detailed description of a related known technology may obscure the gist of the embodiments disclosed herein, the detailed description thereof will be omitted. In addition, it should be noted that the attached drawings are only intended to facilitate easy understanding of the embodiments disclosed herein, and the technical ideas disclosed herein should not be construed as being limited by the attached drawings.

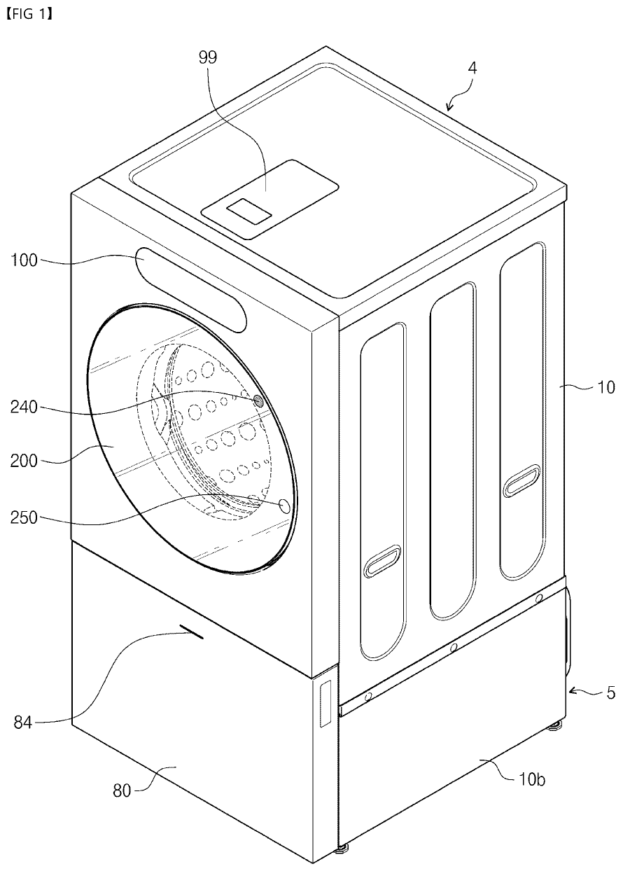

FIG. 1 shows an outer appearance of a laundry treating apparatus of the present disclosure.

The laundry treating apparatus of the present disclosure may be equipped as one of a washing machine 1 and a dryer 2, or may include at least one of a composite apparatus 4 in which the washing machine 1 and the dryer 2 are integrated, and an auxiliary apparatus 5 disposed beneath the composite apparatus 4.

A following description will be based on the laundry treating apparatus of the present disclosure being equipped as the composite apparatus 4 and the auxiliary apparatus 5 disposed beneath the composite apparatus 4. However, this is only for a purpose of description, and the laundry treating apparatus of the present disclosure does not exclude the washing machine 1, the dryer 2, or a form in which the washing machine 1 and the dryer 2 are arranged in a vertical direction.

The composite apparatus 4 of the present disclosure may include a cabinet 10 forming an outer appearance thereof. An opening through which laundry may be withdrawn and inserted may be formed in a front surface of the cabinet 10, and the opening may be opened and closed by a door 200.

The door 200 may be rotatably coupled to the cabinet 10 so as to selectively open and close the opening. When the door 200 is fixed or locked to the cabinet 10, only a transparent material may be exposed from a front surface thereof. To this end, the front surface of the door 200 may be made of glass or a transparent material such as plastic or acrylic.

A control panel 100 that receives a command to control the laundry treating apparatus of the present disclosure or displays information to the outside may be disposed above the door 200.

The cabinet may include a front panel 11 forming a front surface thereof, and the control panel 100 may be installed on the front panel 11.

The control panel 100 may be equipped with an inputter to receive various commands from the user. The control panel 100 may be equipped with a display that displays information of the laundry treating apparatus on the outside. At least a portion of the control panel 100 may be equipped as a touch panel to perform both functions of the inputter and the display.

The control panel 100 may have a width greater than a height, and may be formed in an oval shape or a shape like a running track. Therefore, the control panel 100 may display more information or more easily display completed sentences, phrases, and the like than when it is formed in a circular shape.

The control panel 100 may receive a command to perform a course or display a state of performing the course, information necessary to perform the course or the like.

The control panel 100 may include one or more of a plurality of buttons or a touch panel for receiving the command from the user, a microphone for receiving a user's voice, a camera or a proximity sensor for receiving a user's operation or state, a screen for displaying visual information to the user, and a speaker for transmitting auditory information to the user.

When the laundry treating apparatus of the present disclosure is equipped in a front-load type in which the opening is formed in the front surface of the cabinet, the control panel 100 may be disposed above the door 200 on the front surface of the cabinet 10. Thus, accessibility and identifiability may be secured.

In one example, when the laundry treating apparatus of the present disclosure is equipped in a top-load type in which the opening is formed in a top surface of the cabinet, the control panel 100 may be disposed in front of the door 200 on the top surface of the cabinet 10.

When the auxiliary apparatus 5 is disposed beneath the composite apparatus 4, the control panel 100 may be equipped as a composite panel that may control at least one of the composite apparatus 4 and the lower auxiliary apparatus 5 at the same time.

When the composite apparatus 4 of the present disclosure performs an operation of the dryer 2, a filter 99 that filters drum air from the outside of the drum may be disposed in an upper portion of the cabinet 10.

The filter 99 may filter foreign substances in a circulation duct that is accommodated inside the cabinet 10 and circulates air, and the circulation duct may be disposed inside the cabinet 10 closer to the upper portion than to a lower portion of the cabinet 10 such that the filter 99 is able to be withdrawn upward from a top panel 13 of the cabinet. A structure of the circulation duct will be described later.

The door 200 may be coupled to the cabinet 10 in a push button form. When the door 200 is pressed toward the cabinet 10, the door 200 may sequentially repeat opening and closing the opening.

When the door 200 is formed in the push button form, even in a situation in which the user is not able to pull the door 200, such as when the user is holding the laundry in both hands, the door 200 may be sequentially fixed to the cabinet 10 or separated from the cabinet 10 when a pressure is applied toward the opening or the cabinet 10.

The door 200 is rotatably coupled to a hinge disposed on one side of the opening. Therefore, it is preferable that a locker that couples or fixes the door 200 to the cabinet 10 is installed in an area opposite to the hinge with respect to the opening.

The door 200 may have a pressing portion 250 that induces the user to press a place corresponding to the locker on an outer surface thereof. The pressing portion 250 may be marked on a surface to be distinguished from other areas, or may be equipped as a separate light or the like to be visually distinguished.

The door 200 may further include a sensor 240 that receive a user's pressurization or touch and separates the door 200 from the cabinet 10.

The sensor 240 may be equipped as a component that may detect a user's physical contact. For example, the sensor 240 may include any component as long as it is able to sense the user's physical contact, such as a touch film, a touch panel, a physical button, a piezoelectric element, and the like installed on the door 200.

The door 200 may be opened at the cabinet 10 even when it is not pressed toward the cabinet 10 when the user touches or presses the sensor 240. As a result, the door 200 may be prevented in advance from being damaged or scratched when pressed by the user, an object, or the like.

The sensor 240 may be disposed near the pressing portion 250. Accordingly, the user may intuitively recognize that the sensor 240 and the pressing portion 250 are areas that receive a user's input.

The sensor 240 may be built in the door 200, but may be marked on the outer surface of the door 200. Accordingly, the sensor 240 may further include a separate light emitting body. In one example, an area where the sensor 240 is installed may be indicated via marking, shading, and the like on the surface of the door 200.

The laundry treating apparatus of the present disclosure may additionally include the auxiliary apparatus 5 disposed beneath the composite apparatus 4. The auxiliary apparatus 5 may be disposed beneath the composite apparatus 4, and the composite apparatus 4 may be disposed on top of the auxiliary apparatus 5.

The auxiliary apparatus 5 may include an auxiliary cabinet 10b disposed beneath the cabinet 10 of the composite apparatus 4, and a drawer 80 that is extended forward from the auxiliary cabinet 10b.

An auxiliary inputter 84 that may receive an extension command for extending the drawer 80 forward from the user may be disposed at a front side of the drawer 80.

The multi-function inputter 84 may be equipped as any component as long as it is able to receive the extension command by coming into contact with a user's body. For example, the multi-function inputter 84 may be equipped as a touch panel or a button.

An installation vertical level of the composite apparatus 4 may become higher because of the auxiliary apparatus 5. Therefore, when the composite apparatus 4 is equipped in the front-load type in which the door 200 is disposed in front of the cabinet 10, a location of an opening 14 also becomes higher, so that the user may easily access the door 200 without bending his or her back.

Detailed configurations of the composite apparatus and the auxiliary apparatus will be described later.

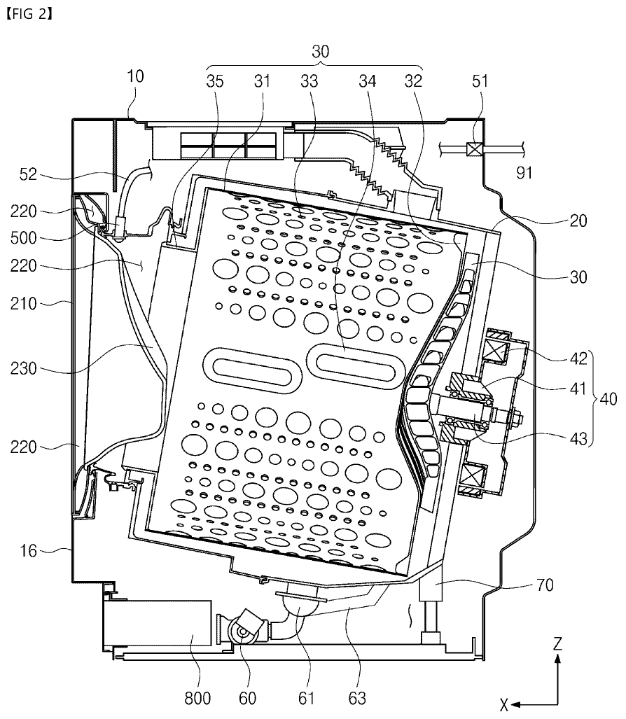

FIG. 2 shows an internal cross-section when a laundry treating apparatus of the present disclosure is equipped as a composite apparatus.

The laundry treating apparatus of the present disclosure may include a tub 20 accommodated inside the cabinet 10 to store water therein, and a drum 30 rotatably accommodated in the tub 20 to store water therein.

The tub 20 may include a tub body 21 formed in a cylindrical shape and including an inlet 22 at a front side thereof.

The tub body 21 may be made of a plastic material or the like, and the inlet 22 may protrude from a front side of the tub body 21 in a cylindrical shape that has a diameter smaller than a diameter of the tub body 21.

The inlet 22 may be in communication with the opening 14 of the cabinet 10.

In one example, the tub 20 may further include a gasket 23 sealing a space between the inlet 22 and the opening 14.

The gasket 23 may be formed as a separate component from the tub body 21. The gasket 23 may be formed in a ring shape that seals the space between the inlet 22 and the opening 14.

The gasket 23 may be made of an elastic material. Therefore, even when vibration occurs in the tub 20, the gasket 23 may maintain the state of sealing the space between the opening 14 and the inlet 22, and may prevent the vibration from being transmitted to the opening 14 or the door 200.

The drum 30 may include a drum body 31 that is rotatably disposed in the tub body 21 to store the laundry therein, and an entrance 35 that is disposed in front of the drum body 31 and is in communication with the inlet 22 and the opening 14.

The drum body 31 may be formed in a cylindrical shape, and may include a through-hole 33 in communication with the inside of the tub body 21 formed in a rear surface or an outer circumferential surface thereof. The drum body 31 may be made of a metal material.

The laundry treating apparatus of the present disclosure may include a water supply portion 50 that supplies water to the tub 20, and a drainage portion 60 that drains water from the tub 20.

The display portion 150 may display apparatus information I indicating which product's state is currently being displayed.

The apparatus information I may include composite information I1 that may control the composite apparatus 4. For example, the composite information I1 may include one or more of phrases, icons, and pictograms such as “washing and drying” or “composite apparatus”.

The apparatus information I may also include auxiliary information I2 that may control the auxiliary apparatus 5. For example, the auxiliary information I2 may include one or more of phrases, icons, and pictograms such as “mini wash” or “auxiliary apparatus”.

The water supply portion 50 may include a water supply valve 51 that is coupled to the cabinet 10 and connected to an external water supply source to selectively supply water, and a water supply pipe 52 that extends from the water supply valve 51 and transmits water supplied from the external water supply source. The water supply pipe 52 may be coupled to the tub body 21, or may have a distal end coupled to the gasket 23.

As long as the water supply pipe 52 is able to supply water to the tub 20, the water supply pipe 52 may be coupled to any portion of the tub 20.

The drainage portion 60 may include a discharge pipe 61 that is connected to a lower portion of the tub 20 to discharge water from the tub 20, a drainage pump 62 that provides power to discharge water supplied from the discharge pipe 61 to the outside of the cabinet 10, and a drainage pipe 63 that extends from the drainage pump 62 to the outside of the cabinet 10 to discharge water.

The laundry treating apparatus of the present disclosure may further include a water level sensor 24 that senses a water level of the tub 20. The water level sensor 24 may be equipped as any component as long as it is able to sense the water level inside the tub 20. For example, the water level sensor 24 may include a communication pipe in communication with the tub 20 and having a closed distal end, and a device positioned on the communication pipe to sense a pressure change inside the communication pipe.

The laundry treating apparatus of the present disclosure may further include a support 70 that supports the tub 20 inside the cabinet 10.

The support 70 may include at least one of a suspension that supports a lower portion of the tub 20 and a spring that supports an upper portion of the tub 20.

The laundry treating apparatus of the present disclosure may include a driver 40 having the same structure as that in the general washing machine 1.

In addition, the laundry treating apparatus of the present disclosure may further include a heat supply portion 90 that may circulate air inside the tub 20 or the drum 30 and may heat the air.

The heat supply portion 90 may be disposed downward of the tub 20.

However, because the tub 20 is the closest component to the drum 30 and the drainage portion 60 is disposed beneath the tub 20, the heat supply portion 90 may be seated on the tub 20.

The heat supply portion 90 may be disposed to be seated on the tub 20. That is, the heat supply portion 90 may be disposed upward of the opening of the tub.

The heat supply portion 90 may include at least one of a circulation flow channel 91 extending from the tub 20 in at least one of a front and rear direction and a left and right direction to circulate air inside the tub 20, an evaporator 92 accommodated in the circulation flow channel 91 to cool the air and condense moisture, a condenser 93 disposed downstream of the evaporator to heat the air, a compressor 94 disposed outside the circulation flow channel 91 to supply a refrigerant that heats the air to the condenser 93, an expansion valve that expands and cools the refrigerant discharged from the condenser 93 and delivers the refrigerant to the evaporator 92, and a circulation fan 96 disposed inside the circulation flow channel 91 to provide power to circulate the air.

The circulation flow channel 91 may be constructed such that one end is connected to an upper rear portion of the tub body 21 and the other end is connected to an upper front portion of the tub body 21 or to the gasket 23.

The circulation fan 96 may operate such that air is sucked into the circulation flow channel 91 from the rear of the drum 30 and the air is discharged into the drum body 31 via the entrance 35.

As a result, hot air generated from the heat supply portion 90 may be evenly supplied to the drum body 31 by being introduced into the entrance 35, and the laundry may be evenly dried. In addition, air that has dried the laundry may be smoothly introduced into one end of the circulation flow channel 91 by passing through the through-hole 33 by a negative pressure provided by the circulation fan 96.

As a result, the heat supply portion 90 may be constructed to supply hot air into the drum body 31 even when the drum 30 is accommodated in the tub 20, has a plurality of through-holes 33 formed in the outer circumferential surface thereof, and thus has high air resistance.

The heat supply portion 90 may omit a water collector and a water storage tank that collect condensate because the tub 20 is disposed thereunder. That is, water condensed inside the circulation flow channel 91 may be collected in the tub 20 and discharged to the drainage portion 60.

The laundry treating apparatus of the present disclosure may perform a plurality of courses to treat the laundry based on the above-mentioned components. The courses may include a washing course to remove foreign substances from the laundry and a drying course to remove moisture from the laundry.

The laundry treating apparatus of the present disclosure may include an integrated controller in which a controller that performs the washing course and a controller that performs the drying course are integrated. The integrated controller may be built into the control panel 100, or may be equipped as a control panel disposed separately from the control panel 100 and mounted inside the cabinet 10.

The speaker may convert the information received from the integrated controller or the control panel into sound waves.

The laundry treating apparatus of the present disclosure may include the driver 40 coupled to the tub 20 to rotate the drum 30.

The driver 40 may include a stator 41 coupled to a rear portion of the tub body 21, a rotor 42 rotated by the stator 41, and a rotation shaft 43 connecting the rotor 42 with the drum 30.

The tub body 21 may have a bearing housing installed on a rear surface thereof that allows the rotation shaft 43 to pass therethrough and rotatably supports the rotation shaft 43.

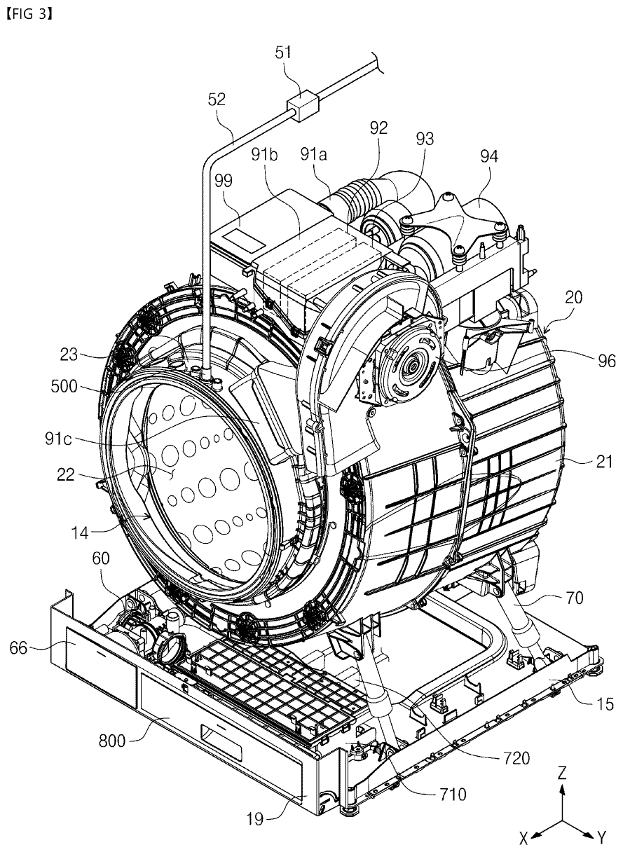

FIG. 3 shows an internal structure of a cabinet of a laundry treating apparatus of the present disclosure in detail.

The circulation flow channel 91 may be disposed to extend in a ‘¬’-shape on the tub 20 to secure a volume for air to flow or area sizes of the evaporator and the condenser.

That is, the circulation flow channel 91 may extend forward from one side at an upper rear portion of the tub body 21, and then extend toward the other side at an upper front portion of the tub body 21.

The circulation flow channel 91 may include an inflow portion 91a extending from the rear portion to the front portion of the tub body 21, a flowing portion 91b extending from the inflow portion to the other side of the front portion of the tub body 21 or to the gasket 23, and an exhaust portion 91c extending downward from the flowing portion and in communication with a space formed inward of the gasket 23.

The duct may extend in the left and right direction on the tub 20, and the filter 99, the evaporator 92, and the condenser 93 may be sequentially disposed therein.

The circulation fan 96 may be constructed to be in communication with the circulation flow channel 91.

The circulation fan 96 may be installed inside the circulation flow channel 91, and may include a housing connecting the flowing portion with the exhaust portion.

The circulation fan 96 may be disposed at the front portion of the tub body 21 to evenly distribute a weight of the rear portion of the tub body 21 to which the driver 40 is coupled.

The circulation fan 96 may be operated such that air flows from the inflow portion to the exhaust portion.

The water supply pipe 52 of the water supply portion 50 may be connected to the gasket 23. A nozzle 500 coupled to a distal end of the water supply portion 50 may be installed on the gasket 23. The nozzle 500 may evenly spray water supplied from the water supply pipe 52 into the drum body 31.

The laundry treating apparatus of the present disclosure may further include a circulator 65 that recirculates and supplies water from the tub 20.

The circulator 65 may include a circulation pump that is in communication with the drainage pump 62 or is disposed on one side of the drainage pump 62, and a circulation hose that re-supplies water drained from the tub body 21 to the tub 20.

As a result, water may also be saved by reusing water from the tub 20 during the washing cycle or a rinsing process, and a washing efficiency may also be increased by evenly dissolving the detergent or the like via the circulator 65.

The laundry treating apparatus of the present disclosure may further include a detergent box 700 that stores therein the detergent to be supplied to the tub 20.

The detergent box 700 may be disposed downward of the tub 20. The detergent box 700 may be prevented from interfering with the heat supply portion 90 disposed above, and may be exposed to the user without difficulty even when the composite apparatus 4 is raised because of the auxiliary apparatus 5.

The detergent box 700 may be equipped with a detergent body that accommodates the detergent therein, and a detergent pump that sprays the detergent accommodated in the detergent body into the tub 20. Accordingly, water from the tub 20 may be prevented from arbitrarily infiltrating into the detergent box 700, or the detergent may be prevented from being arbitrarily supplied into the detergent box 700.

The detergent box 700 may supply the detergent to at least one of the drainage portion 60 and the circulator 65.

When supplying the detergent to the circulator 65, the detergent may be supplied to the tub 20 while operating the circulation pump or the like, the detergent may be more easily dissolved in water during the circulation process, and the detergent may be evenly supplied to the laundry.

A filter 800 may be disposed between the drainage pump 62 and the circulator 65, so that the foreign substances discharged from the tub 20 may be prevented from being re-introduced into the circulator 65.

The filter 800 may be exposed forward on one side of the detergent box 700 and may be detachable forward.

The cabinet may further include a base 15 that supports the filter 800 and the detergent box 700.

The base 15 may form a bottom surface of the cabinet 10.

The base 15 may support the support 70, and may support the detergent box 700 and the filter 800 so as not to interfere with the support 70.

The detergent box 700 may be detachably disposed on the base 15, and may be withdrawable forward from the base 15. As a result, the user may continuously replenish the detergent in the detergent box 700, and may also wash the detergent box 700.

A step panel 16 that guides the withdrawal and the insertion of at least one of the detergent box 700 and the filter 800 and is disposed under the front panel 11 may be further included in front of the base 15.

The step panel 16 may have a hole through which the detergent box 700 and the filter 800 are withdrawn and inserted, and may block the base 15 from being exposed to the outside.

The step panel 16 may be formed separately from the front panel 11. As a result, the front panel 11 and the step panel 16 may be made of different materials. As a result, even when the front panel 11 is made of a metal material or the like that is rigid or difficult to form, the step panel 16 may be made of a material that is easy to form so as to guide the withdrawal and the insertion of at least one of the detergent box 700 and the filter 800 or expose at least one of those.

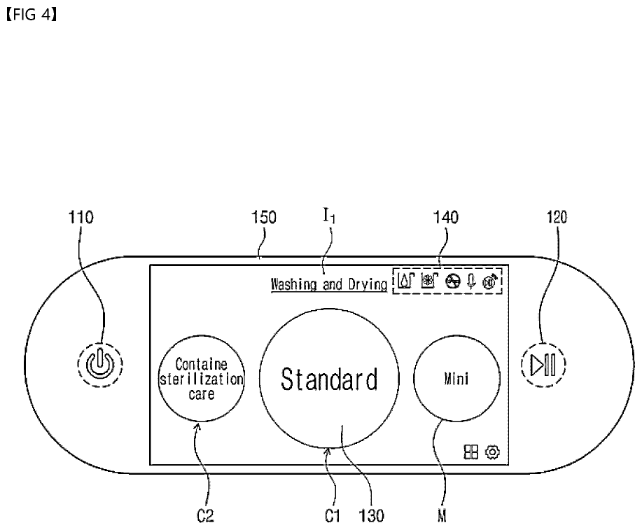

FIG. 4 shows a structural embodiment of the control panel 100 of the laundry treating apparatus of the present disclosure.

A mode of the control panel 100 may be switched to one of a washing mode that receives the command to perform the washing course or displays a state of the washing course and a drying mode that receives the command to perform the drying course or displays a state of the drying course.

In addition, when there is the auxiliary apparatus to be described below, the mode may be switched to an auxiliary mode that receives a command to execute the auxiliary apparatus or displays a state of the auxiliary apparatus.

The control panel 100 should implement all of the washing mode to perform the washing course, the drying mode to perform the drying course, and the auxiliary mode to execute the auxiliary apparatus.

Therefore, it is preferable that the control panel 100 is equipped entirely as a touch panel with physical buttons or the like omitted, and the washing mode, the drying mode, and the auxiliary mode are selectively displayed. As a result, a plurality of buttons and indicators to respectively perform the washing mode, the drying mode, and the auxiliary mode separately may be omitted.

The control panel 100 may include a display portion 150 in a central square portion.

Each of a power unit 110 that receives a power command to supply the power to the control panel 100 and an execution unit 120 that receives an execution command to perform a selected course may be disposed on one side of the display portion 150.

When the power unit 110 is pressed, the control panel 100 may be activated by standby power and consume the power, but the integrated controller may not consume the power.

The execution unit 120 should be pressed so that the integrated controller may be controlled to perform a course to treat the laundry by receiving the power.

The power unit 110 and the execution unit 120 may be equipped as touch areas where a touch input is available, and thus, illuminate when the touch input is available and turn off when the touch input is not available.

The display portion 150 may display weight information related to a sensed weight of the laundry and state information related to selected course and option.

In addition, the display portion 150 may be equipped as a touch panel and also perform roles of a course selector 130 that receives a course selection command to select one of the courses provided by the laundry treating apparatus, and an option selector 140 that receives an option selection command to add additional conditions and functions to the course.

For example, the course selector 130 that may select the course may be displayed on the display portion 150. For example, a selected course C1 may be displayed in a large size, and alternative courses C2 and C3 may be displayed in a small size on left and right sides. Thus, the display portion 150 may perform a function of the course selector 130.

The display portion 150 may further include a state display 153 that displays the state of the laundry treating apparatus. The state display 153 may display one or more of an internal water level state, an internal temperature state, a lock state, a sound transmission state, and a course progress state in a form of icons or the like.

The option selector 140 may be disposed outward of the course selector 130 or the area where the course is displayed. The option selector 140 may be disposed to be spaced downwardly apart from the state display 153.

When the option selector 140 is pressed, options that may be selected or adjusted may be displayed on the display portion 150. During such process, the display of the course selector 130 and the course C may disappear.

In one example, the display portion 150 may display an apparatus connector M that may activate the auxiliary apparatus 5 or control the auxiliary apparatus 5.

When the apparatus connector M is pressed, the display portion 150 is able to receive a command related to the auxiliary apparatus 5 while displaying a state related to the auxiliary apparatus 5.

The apparatus connector M may be marked as one or more of phrases such as “mini” or “auxiliary apparatus”, pictograms, and icons.

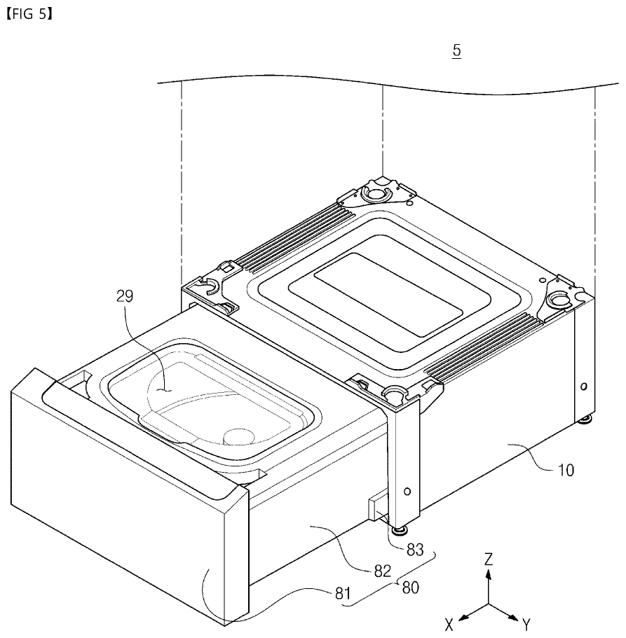

FIG. 5 shows an outer appearance of an auxiliary apparatus that may be included in a laundry treating apparatus of the present disclosure.

The auxiliary apparatus 5 may have a height and a volume smaller than those of the composite apparatus 4.

The auxiliary apparatus may be additionally installed to the composite apparatus 4 as the auxiliary laundry treating apparatus. In one example, the auxiliary apparatus 5 may be equipped independently.

When the laundry treating apparatus of the present disclosure is equipped as the auxiliary apparatus 5, the cabinet 10 may include an auxiliary cabinet 10b whose height is smaller than a width in the left and right direction and a length in the front and rear direction.

Because the auxiliary cabinet 10b has the small height, the auxiliary cabinet 10b may be disposed beneath the composite apparatus 4.

In one example, the auxiliary apparatus 5 may be disposed on top of the composite apparatus 4, but for the convenience of description, a following description will be based on assumption that the auxiliary apparatus 5 is disposed beneath the composite apparatus 4 or is disposed independently.

The auxiliary cabinet 10b may have the opening formed in the front surface thereof.

The auxiliary apparatus 5 may further include the drawer 80 that may be retracted and extended via the opening in the auxiliary cabinet 10b.

The drawer 80 may include a drawer body 82 that accommodates therein a tub accommodating water therein or a rotating drum, a drawer panel 81 that is disposed in front of the drawer body 82 to open and close the opening, and a rail 83 that allows the drawer body 82 to be retracted into and extended from the auxiliary cabinet 10b.

The drawer body 82 may be formed in a casing shape with an open top, and may further include an auxiliary door 29 that opens or closes the tub and the drum inside.

The auxiliary apparatus 5 may have the drawer 80, so that a use thereof may be prevented from being interfered with even when there is another laundry treating apparatus or home appliance thereon.

The auxiliary apparatus 5 may be equipped with its own control panel on drawer 80.

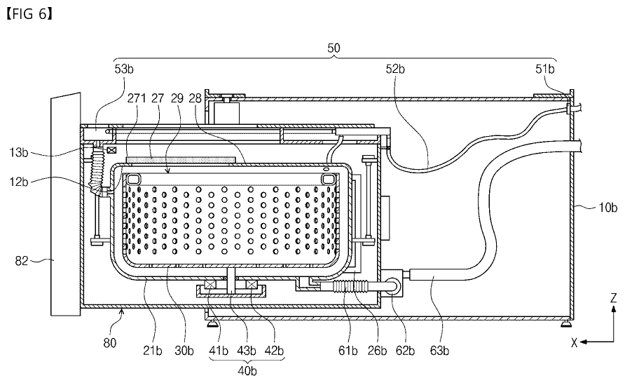

FIG. 6 shows an internal structural embodiment when a laundry treating apparatus of the present disclosure is equipped as an auxiliary apparatus.

The auxiliary apparatus 5 may include, inside the drawer 80, an auxiliary tub 20b that accommodates water therein and an auxiliary drum 30b that is rotatably disposed in the auxiliary tub and is able to accommodate the laundry therein.

The auxiliary tub 20b and the auxiliary drum 30b may have heights smaller than diameters, and may have inlets into which the laundry is introduced in top surfaces thereof.

The auxiliary apparatus 5 may further include a water level sensor 26b that senses a water level of the auxiliary tub 20b. The water level sensor 26b may be in communication with the auxiliary tub 20b from the outside of the auxiliary tub 20b and sense the water level of the auxiliary tub 20b in a manner of sensing a pressure change inside the auxiliary tub 20b.

The auxiliary apparatus 5 may include the auxiliary door 29 coupled to an upper portion of the auxiliary tub 20b to prevent water or the laundry inside the auxiliary tub 20b from being arbitrarily leaked.

In addition, the auxiliary apparatus 5 may include an auxiliary driver 40b coupled to the auxiliary tub 20b to rotate the auxiliary drum 30b.

The auxiliary driver 40b may be disposed under the auxiliary tub 20b to rotate the auxiliary drum 30b.

The auxiliary driver 40b may include an auxiliary stator 41b coupled to a lower portion of the auxiliary tub 20b to generate a rotating magnetic field, an auxiliary rotor 42b rotated by the auxiliary stator 41b, and an auxiliary rotation shaft 43b rotated by the auxiliary rotor and coupled to a lower portion of the auxiliary drum 30b.

The auxiliary apparatus 5 of the present disclosure may further include an auxiliary water supply portion 50b that supplies water to the auxiliary tub 20b.

The auxiliary water supply portion 50b may include an auxiliary water supply valve 51b coupled to the auxiliary cabinet 10b, an auxiliary water supply pipe 52b that extends from the auxiliary water supply valve 51b to the drawer and supplies water, and an auxiliary box 53b that guides water supplied from the auxiliary water supply pipe 52b to the tub.

The auxiliary water supply pipe 52b may be formed in a structure that extends forward by a length of the drawer 80 that extends from the auxiliary cabinet 10b. The auxiliary box 53b may store the introduced detergent therein.

The auxiliary apparatus 5 of the present disclosure may further include an auxiliary drainage portion 60b that drains water from the auxiliary tub 20b.

The auxiliary drainage portion 60b may include an auxiliary discharge pipe 61b that discharges water from the auxiliary tub 20b, an auxiliary pump 62b coupled to the auxiliary discharge pipe 61b to provide power to discharge water, and an auxiliary drainage pipe 63b extending from the auxiliary pump 62b to the outside of the auxiliary cabinet 10b.

The auxiliary drainage pipe 63b may be formed in a structure that extends forward by the length of the drawer 80 that extends from the auxiliary cabinet 10b.

The support 70 may include an auxiliary suspension 70d connecting an inner surface of the drawer 80 with an outer surface of the auxiliary tub 20b.

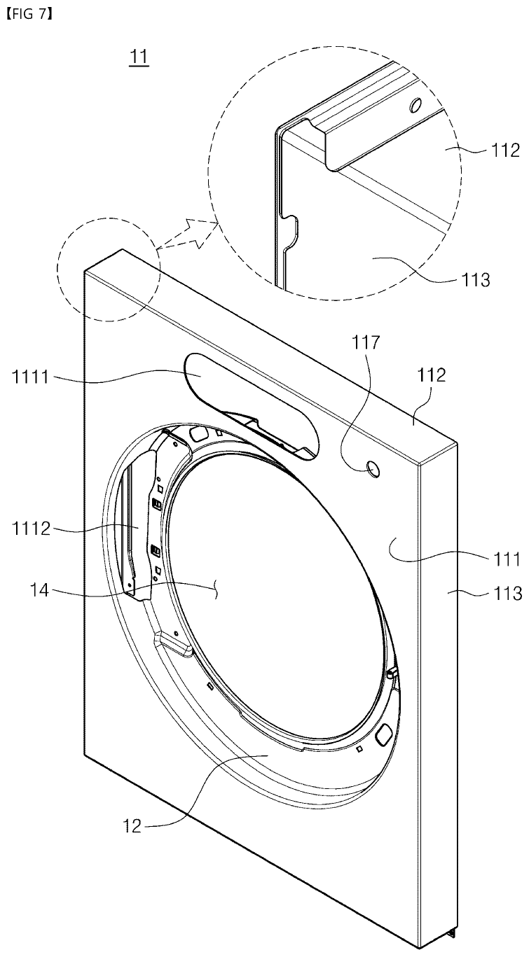

FIG. 7 shows a structural embodiment of a front panel of a laundry treating apparatus of the present disclosure.

The control panel 100 may be disposed on the front surface of the cabinet 10. Accordingly, the user who is far away from the laundry treating apparatus may easily identify a state of the laundry treating apparatus. The control panel 100 may be disposed upward of the opening 14 so as to facilitate physical contact of the user. As a result, the control panel 100 may be disposed at a location higher than the opening 14 and lower than the top panel of the cabinet 10 on the front surface of the cabinet 10.

The front panel 11 forming a front portion of the cabinet 10 of the laundry treating apparatus of the present disclosure may support the control panel 100 with an inner surface thereof. To this end, the front panel 11 may have an area that supports the control panel 100 with an inner surface thereof upward of the opening 14, thereby supporting the control panel 100 with the area positioned upward of the opening 14. To this end, the front panel 11 may have an upper plate 112 positioned at a vertical level to be parallel to the top panel of the cabinet 10.

The front panel 11 may be formed integrally or formed as a single plate from an upper end parallel to the top panel to a lower end positioned downward of the opening 14.

Accordingly, the front panel 11 may omit a separate decorative panel separately coupled to a location above the opening and exposed to the outside of the cabinet while fixing the control panel 100.

In addition, the front panel 11 may be formed as the single plate, so that an entirety thereof may exhibit a uniform texture. Further, a dividing line itself positioned between components may be omitted, so that aesthetics may be maximized.

In addition, because the front panel 11 is formed integrally, air or moisture may be blocked from being introduced into the control panel 100 via the front surface of the cabinet.

The front panel 11 may be formed in a casing shape that defines an accommodating space therein. That is, the front panel 11 may not be formed as a flat plate, but may be formed in three dimensions to have a volume. Accordingly, even when the front panel 11 is formed as the single plate, not only the durability may be enhanced and the shape thereof may be maintained even against external impact, but also the control panel 100 may be accommodated to be stably protected from the external impact, moisture, or air.

Specifically, the front panel 11 may include a front plate 111 having the opening 14 formed therein and exposed forward of the cabinet 10, the upper plate 112 disposed on top of the front plate 111 and extending rearward, and side plates 113 extending rearward from both sides of the front plate 111.

The upper plate 112 may extend parallel to the top panel 13 to form a portion of the top surface of the cabinet 10, and the side plate 113 may extend parallel to a side panel 17 to form a portion of the side surface of the cabinet 10.

The upper plate 112 and the side plate 113 may extend from the front plate 111 with the same width or length.

The front panel 11 may define therein a rectangular cuboid accommodating space formed by the front plate 111, the upper plate 112, and the side plates 113.

The upper plate 112 and the side plates 113 may shield at least a portion of top and side surfaces of the control panel 100 when the control panel 100 is fixed to the front plate 111.

The upper plate 112 may block at least a portion of the top surface of the control panel 100 from being exposed to a top surface of the front panel 11, and the side plate 113 may block at least a portion of the side surface of the control panel 100 from being exposed to a side surface of the front panel 11.

For example, the upper plate 112 of the front panel 11 may extend from the front plate 111 with a thickness greater than a thickness of the control panel 100, and the side plate 113 of the front panel 11 may extend from the front plate 111 with a thickness greater than that of the control panel 100. In this case, the control panel 100 may be completely accommodated in and protected by the front panel 11.

The front plate 111 may include a display hole 1111 that exposes at least a portion of the control panel 100 forward. The display hole 1111 may be formed such that a display panel that serves as the display for visually displaying the information to the outside of the control panel 100 is exposed to the outside.

The display hole 1111 may have an area size and a shape for not only the display but also an entirety of the inputter in the control panel 100 to be exposed to the outside. For example, the display hole 1111 may be formed in a rectangular or running track shape with a width greater than a height.

The front plate 111 may further be formed with a press hole 117 that allows a separate physical button to be pressed.

A seating portion 12 that may accommodate and sit at least a portion of the door 200 thereon may be formed on an outer circumferential surface of the opening 14. A hinge coupling hole 1112 formed to allow a hinge 300 coupled to the door 200 to pass therethrough may be formed at one side of the seating portion 12.

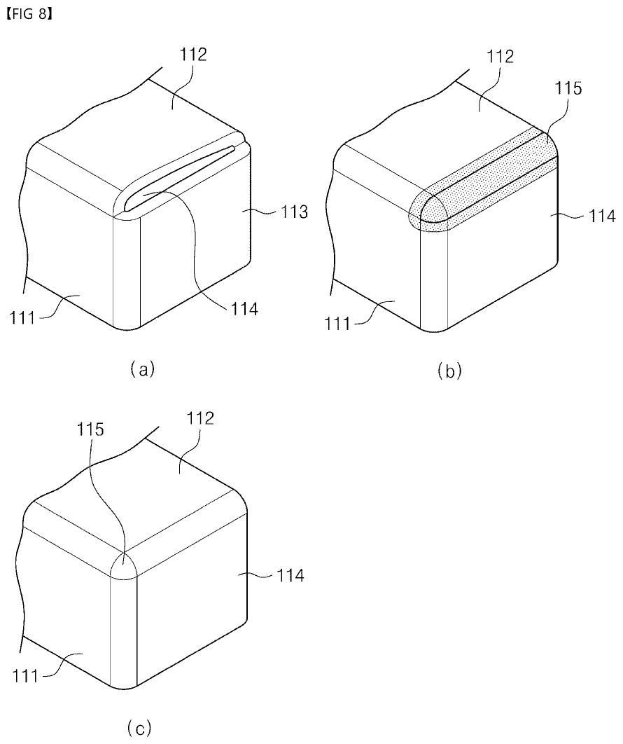

FIG. 8 shows a method for manufacturing a corner of the front panel.

Referring to (a) in FIG. 8, to define the space for accommodating the control panel 100 while the front panel 11 is formed as the integral plate, the upper plate 112 should be manufactured in a form that extends on top of and parallel to a top surface of the front plate 111 and then should be bent rearward, and then the side plates 113 should be manufactured in a form that extends on and laterally parallel to both side surfaces of the front plate 111 and then should be bent rearward.

In other words, after the integral plate that is the material of the front panel 11 is manufactured by being cut into the front plate 111, the upper plate 112, and the side plates 113 in the flat shape, the upper plate 112 and the side plates 113 should be bent at 90 degrees.

The plate made of the metal material may be deformed and stretched to a certain extent during the process of being molded by receiving an external force such as a bending process, and the deformation may become more severe in areas where stress is concentrated.

Therefore, a safety hole 114 may be formed at a corner where the upper plate 112, the side plate 113, and the front plate 111 all come into contact with each other. To this end, inwardly formed grooves may be formed at both ends of an edge where the upper plate 112 and the front plate 111 are separated from each other, and inwardly formed grooves may be formed at both ends of an edge where the side plate 113 and the front plate 111 are separated from each other.

Accordingly, even when the deformation or tension occurs in the bent portions during the process of the upper plate 112 and the side plates 113 being bent, the upper plate 112 and the side plates 113 may be prevented from colliding or interfering with each other because of a free space of the safety hole 114, and a shape of an apex of the front plate 111 may be prevented from being changed to be different from that of other portions.

Referring to (b) in FIG. 8, respective areas of the upper plate 112 and the side plate 113 facing each other may be joined via a process such as welding. In addition, the safety hole 114 may also be filled via the process such as the welding.

An area corresponding to the safety hole 114 may serve as the apex of the front panel 11 via the welding, and the upper plate 112 and the side plate 113 may be connected to each other to form a united aesthetic.

Accordingly, the front panel 11 may be formed as the integral plate without a separate coupling member or fastening member even when the accommodating space is formed therein, and the upper plate 112 and the side plate 113 may be prevented from being separated from each other because of internal stress.

Referring to (c) in FIG. 8, the front panel 11 may have the welded portion surface-treated. In addition, an entire area of the front panel 11 may be surface-treated, not just the welded portion. Accordingly, not only welding traces may be removed from the front panel 11, but also an entire surface of the front panel 11 may form a certain level of gloss and pattern to maximize the aesthetics.

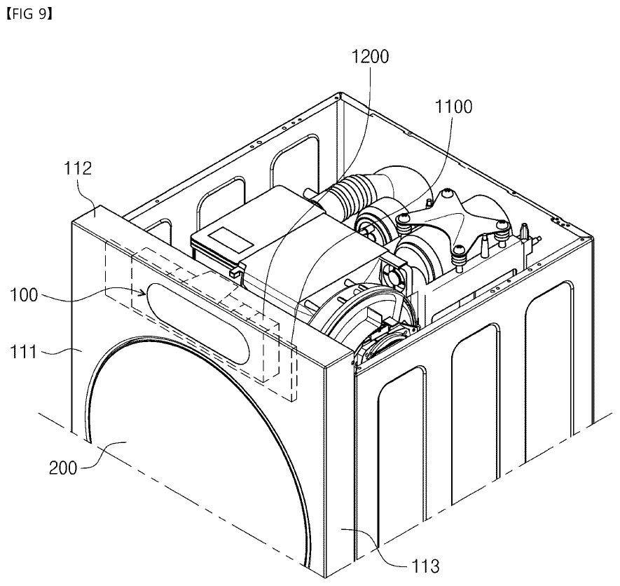

FIG. 9 shows an upper portion of a cabinet in a state in which the control panel is coupled.

The front panel 11 may extend further upward than the tub 20 and the heat supply portion 90 to support and protect the control panel 100.

The top panel 13 may be coupled to a rear portion of the front panel 11. Therefore, the top surface of the front panel 11 may be disposed at a higher vertical level than a top surface of the side panel 17.

The front panel 11 may support the control panel 100 on the inner surface thereof, but may completely accommodate the control panel 100 therein.

The upper plate 112 may block the top surface of the control panel 100 from being exposed to the outside of the front panel 11, and the side plate 113 may block the side surface of the control panel 100 from being exposed to the outside of the front panel 11.

Most of the components accommodated in the cabinet 10 are disposed outward of the front panel 11, except for a gasket or the like. Accordingly, the control panel 100 may be stably protected not only from impact transmitted from the outside of the cabinet 10 but also from vibration or impact generated from the tub 20.

In addition, even when water and air are introduced into joints between the front panel 11, the top panel 13, and the side panels 17, the control panel 100 may be prevented from being exposed to the corresponding water and air.

The control panel 100 may be fixed to the inner surface of the front plate 111 of the front panel 11 without a need for a separate member fixed to the top surface or the side surface of the front panel 11.

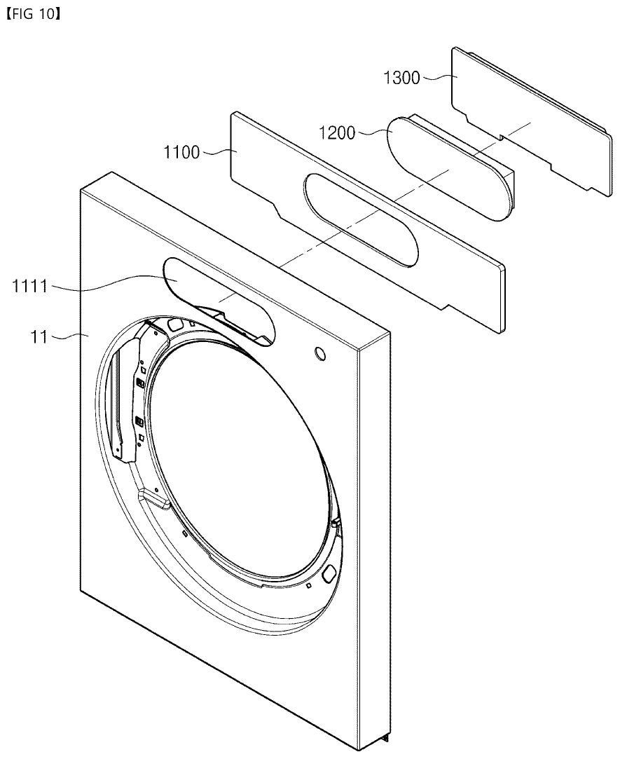

FIG. 10 shows a method of coupling the front panel with the control panel.

When the front panel 11 is made entirely of the metal material, the durability and the aesthetics may be improved, but it may be difficult to form a separate component to support the control panel 100 inside.

Therefore, the laundry treating apparatus of the present disclosure may further include a separate installation panel 1100 for fixing the control panel 100 to the front panel 11.

Because the front panel 11 has the upper plate 112 and the side plates 113, the installation panel 1100 is not able to be supported by or coupled to the corner of the front panel 11. Therefore, the installation panel 1100 may be coupled to a rear surface of the front plate 111 of the front panel 11.

The installation panel 1100 may be equipped to support a load of the control panel 100 and couple the control panel 100 to the front plate 111 while supporting other components of the control panel 100 on a rear surface thereof.

Because the installation panel 1100 is coupled to the rear surface of the front plate 111, the installation panel 1100 is not exposed to the outside of the cabinet 10. Therefore, because the installation panel 1100 is not exposed to the front surface of the cabinet 10, and only components that display visual information of the control panel 100 and the door 200 are exposed to the integrally formed front panel 11, the aesthetics may be improved.

The control panel 100 may include a display panel 1200 that is coupled to the rear surface of the installation panel 1100 and displays the visual information to the outside.

The display panel 1200 may be equipped as a touch panel that may sense the user's physical contact to not only display information to the outside but also to receive a user's command.

The display panel 1200 may be equipped entirely as the touch panel, or may be equipped only partially as the touch panel.

When the display panel 1200 is equipped entirely as the touch panel, an area thereof may be divided. A central area thereof may display the visual information while performing a role of the display portion 150, and may receive a selection command of selecting a course/option from the user while performing a role of the course selector 130 or the option selector 140. Further, both side areas thereof may receive a power command and an execution command while performing roles of the power unit 110 and the execution unit 120.

When the display panel 1200 is equipped only partially as the touch panel, only a central square portion of the display panel 1200 may be equipped as the touch panel, and a touch film that senses a user's touch may be disposed in only specific areas on both sides of the touch panel. In this case, the touch panel may perform the role of the display portion 150, and the touch film may perform the role of the power unit 110 or the execution unit 120.

The display panel 1200 may be equipped as any component as long as it is able to variably display the visual information to the outside and sense the user's touch.

For example, the display panel 1200 may include the touch film, a screen that irradiates light to the touch film, a control panel that controls both the touch film and the screen, and the like.

The control panel 100 may further include a cover panel 1300 disposed at the rear of the display panel 1200 to prevent the display panel 1200 from deviating from the installation panel 1100.

The cover panel 1300 may press the display panel 1200 forward while being coupled to the installation panel 1100 or may also be coupled to the display panel 1200.

As a result, the control panel 100 may be fixed by making surface contact with at least a portion of the rear surface of the front plate 111 of the front panel 11. As a result, the front panel 11 and the control panel 100 integrally vibrate or move, and the control panel 100 and the front panel 11 do not move relative to each other, so that the durability of the control panel 100 may be enhanced.

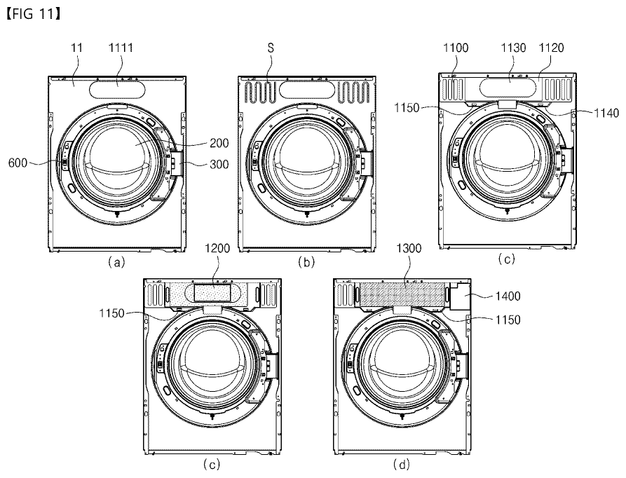

FIG. 11 shows a process of installing the control panel on the front panel.

Referring to (a) in FIG. 11, a locker 600 may be installed and fixed at one side of the seating portion 12 of the front panel 11, and the hinge 300 may be installed at the other side of the seating portion 12. The display hole 1111 may be formed at an upper central portion of the front panel 11.

The front panel 11 may be entirely made of the metal material.

Referring to (b) in FIG. 11, the installation panel 1100 may be made of a resin material that is easier to process than the metal, to form a configuration that is fixedly coupled to the front panel 11 while being coupled to the display panel 1200 and the cover panel 1300.

However, because the front panel 11 is made of the metal material and the surface of the front panel 11 has a texture of an integral metal plate, the front panel 11 does not have holes to which separate fastening members such as bolts are coupled, except for the display hole 1111, a hinge hole 1112, and the opening 14. Therefore, the installation panel 1100 should be able to be fixed without the separate fastening member of the front panel 11.

In addition, the installation panel 1100 should be in close contact with or attached to the front panel 11 to minimize a gap between the display panel 1200 and the front panel 11.

To this end, the laundry treating apparatus of the present disclosure may fix the installation panel 1100 to the front panel 11 with an adhesive S.

The adhesive S may be applied to the rear surface on both sides of the display hole 1111, except for the display hole 1111.

Alternatively, the adhesive S may be applied to a front surface of the installation panel 1100 at both sides.

The adhesive S may be applied in a zigzag manner in a length corresponding to a width and a height of both side surfaces of the installation panel 1100 in a height direction or a width direction.

The adhesive S may be made of any material as long as it is able to support the load of the control panel 100 and maintain the coupling between the control panel 100 and the front panel 11.

Referring to (c) in FIG. 11, the installation panel 1100 may be attached and fixed to the rear surface of the front panel 11 because of the adhesive S.

The installation panel 1100 may include an attachment plate 1110 that is coupled with the adhesive S and is disposed on the rear surface on both sides of the display hole 1111, a mounting plate 1120 that is disposed at a center of the attachment plate 1110 and faces the display hole 1111, and a display through-hole 1130 that extends through the mounting plate 1120 and is in communication with the display hole 1111.

The mounting plate 1120 may provide an area size for the display panel 1200 to be coupled.

The mounting plate 1120 may have a height and a width greater than those of the attachment plate 1110, and may have a grid pattern and a number of reinforcing ribs so as to sufficiently withstand an external force applied via the display panel 1200.

In addition, the mounting plate 1120 may have a thickness greater than that of the attachment plate 1110, and may be disposed to protrude further rearward than the attachment plate 1110.

Therefore, the display panel 1200 and the cover panel 1300 may be coupled to and stably supported by the mounting plate 1120.

The display through-hole 1130 may be formed in the mounting plate 1120 to have an area size and a shape corresponding to those of the display hole 1111. Thus, when the display panel 1200 is coupled to the mounting plate 1120, the screen or a touch film 1210 may be exposed via the display hole 1111.

The installation panel 1100 may have a thickness equal to or greater than a certain thickness, so that a thickness for the fastening member such as the bolt to be coupled may be secured. In addition, because the installation panel 1100 is made of the resin material, various structures that may be coupled to or supported by the display panel 1200 or the cover panel 1300 may be molded.

As a result, even when the fastening member is not able to be coupled to the front panel 11 and a structure in which the front panel 11 itself is able to be coupled with the control panel 100 is excluded, the display panel 1200 and the cover panel 1300 may be fixed to the rear surface of the front panel 11 via the installation panel 1100.

To this end, the installation panel 1100 may include a coupling fixer 1150 that may be coupled with the display panel 1200 and the cover panel 1300 or may fix the display panel 1200 and the cover panel 1300.

The display panel 1200 and the cover panel 1300 may be supported by being coupled to the rear surface of the installation panel 1100.

However, because the display panel 1200 and the cover panel 1300 have certain thicknesses and have their own loads, a momentum to deviate from the rear surface of the installation panel 1100 may continuously occur. In addition, when the vibration generated inside the tub 20 is transmitted to the rear surface of the installation panel 1100, the corresponding momentum may further increase.

Therefore, the coupling fixer 1150 may support the display panel 1200 and the cover panel 1300 at a bottom.

A specific configuration and an embodiment of the coupling fixer 1150 will be described later.

Because the mounting plate 1120 supports the display panel 1200 and the cover panel 1300, the mounting plate 1120 may be a component in the installation panel 1100 to which the greatest load is applied.

Accordingly, a bottom surface of the mounting plate 1120 may have an area size and a shape to be supported on an upper end of the seating portion 12. As a result, the load applied to the mounting plate 1120 may be partially distributed to the seating portion 12.

In addition, the installation panel 1100 may further include a support plate 1140 that extends from the mounting plate 1120 parallel to the mounting plate 1120 and is in contact with the front panel 11 to distribute the load applied to the mounting plate 1120 and strengthen a contact force between the installation panel 1100 and the front panel 11.

The support plate 1140 may serve to expand the area size of the mounting plate 1120 and distribute the load applied to the mounting plate 1120. In addition, the support plate 1140 may extend from a portion of the mounting plate 1120 where the load is most concentrated, so that a size of the installation panel 1100 may be minimized.

For example, because the load of the mounting plate 1120 is concentrated toward the bottom, the support plate 1140 may extend further from the bottom of the mounting plate 1120. The support plate 1140 may extend from the mounting plate 1120 to a top surface of the seating portion 12.

The support plate 1140 may be seated at least partially on the top surface of the seating portion 12. Because the seating portion 12 is formed so as to be recessed rearward in the opening 14, the support plate 1140 may be seated on and supported by a protruding surface of the seating portion 12. Accordingly, the installation panel 1100 may be supported by the seating portion 12 by the support plate 1140, thereby distributing the load to the front panel 11.

Because the seating portion 12 is formed with a curve, the support plates 1140 may extend at both sides of the bottom of the mounting plate 1120, respectively. Accordingly, one of the support plates 1140 may be seated on a left portion of the top surface of the seating portion 12, and the other may be seated on a right portion of the top surface of the seating portion 12.

The support plate 1140 may be formed in a rib shape whose width is much greater than a height, and a portion of a bottom surface thereof that is in contact with the seating portion 12 may be formed with a curve corresponding to that of the seating portion 12.

Referring to (d) in FIG. 11, the display panel 1200 may be fixed by being coupled to the mounting plate 1120 via the coupling fixer 1150. The display panel 1200 may be seated on the rear surface of the mounting plate 1120 such that the screen and the touch film are exposed to the display hole 1111 and the display through-hole 1130.

Referring to (c) in FIG. 11, the cover panel 1300 may be coupled to the installation panel 1100 via the coupling fixer 1150 on a rear surface of the display panel 1200.

The cover panel 1300 may have an area size much greater than the area size of the display panel 1200 so as to shield a rear portion of the display panel 1200 from being exposed.

Because of the cover panel 1300, the display panel 1200 may be prevented from being exposed to heat or moisture generated from the tub 20 or the heat supply portion 90.

The installation panel 1100 may support not only the control panel 100 but also other components. That is, all components that should be disposed on the front panel 11 may be installed on the front panel 11 by being coupled and fixed to the installation panel 1100.

For example, the installation panel 1100 may be coupled with a control panel 1400 that may control individual components such as the heat supply portion 90, the control panel 100, and a communication module that allows the composite apparatus 4 to be in communication with the mini apparatus 5 or an external terminal, a router, and the like.

Because the control panel 1400 is not pressurized by the user or the like, the control panel 1400 may be seated on the attachment plate 1110.

When the laundry treating apparatus of the present disclosure has the speaker, the speaker should be installed on the front panel 11 to emit the sound information to the outside.

Because the front panel 11 is formed as the integral metal plate, it may be difficult to separately dispose a component that supports the speaker.

Therefore, the installation panel 1100 may further include a speaker mounting portion 1160 that provides an installation area for the speaker.

The speaker mounting portion 1160 may be disposed separately from the mounting plate 1120 to prevent interference between the speaker and the control panel 100.

The speaker mounting portion 1160 may be disposed anywhere as long as it is able to support the speaker and emit the sound generated from the speaker to the outside.

For example, the speaker mounting portion 1160 may be disposed on the attachment plate 1110, or may be disposed under the mounting plate 1120.

Because the top surface of the mounting plate 1120 is adjacent to the upper plate 112 of the front panel 11, the speaker mounting portion 1160 may be disposed to extend from the bottom of the mounting plate 1120.

A specific configuration of the speaker mounting portion 1160 will be described later.

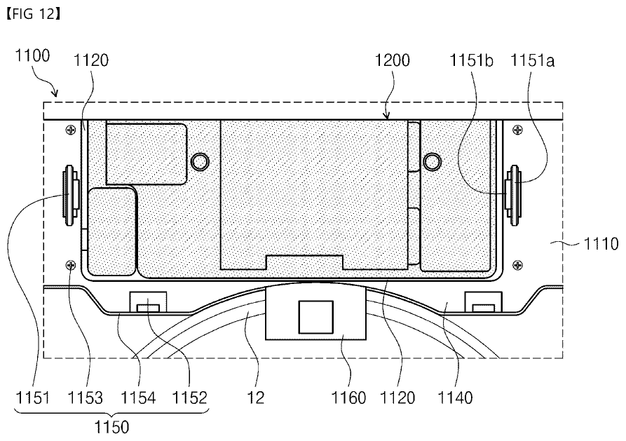

FIG. 12 shows an embodiment of a coupling fixer that couples a display panel to an installation panel.

The coupling fixer 1150 may further include a fixing hook 1151 that protrudes from the rear surface of the installation panel 1100 and is coupled to the display panel 1200.

The fixing hook 1151 may be detachably coupled to the display panel 1200 to fix the display panel 1200 to the installation panel 1100.

The fixing hooks 1151 may fix both sides of the display panel 1200.

The fixing hook 1151 may include a hook rib 1151a that protrudes from the attachment plate 1110 rearward and is disposed at each of both sides of the display panel 1200, and a fixing seating protrusion 1151b that protrudes from the hook rib 1151a toward the display panel 1200 and fixes the rear surface of the display panel 1200.

As a result, a worker or the user may fix or detach the display panel 1200 to or from the installation panel 1100 by pressing the hook rib 1151a.

The coupling fixer 1150 may further include a plurality of fastening holes 1153 into which the fastening members such as the bolts may be coupled. Because the mounting plate 1120 is an area facing the display panel 1200, the fastening member is not able to extend through the display panel 1200, so that the plurality of fastening holes 1153 may be formed in an area excluding the mounting plate 1120.

The fastening holes 1153 may be coupled with the fastening members extending through the cover panel 1300.

The mounting plate 1120 may protrude in a shape corresponding to an outer circumferential surface of the display panel 1200, so that at least a portion of the display panel 1200 may be inserted thereinto. Accordingly, the display panel 1200 may be fixed by being coupled to the fixing hook 1151 after being inserted and seated in the mounting plate 1120.

The coupling fixer 1150 may further include a support rib 1154 that extends rearward from the bottom of the installation panel 1100 or a bottom of the support plate 1140 to support at least one of the display panel 1200 and the cover panel 1300.

The support rib 1154 may support the bottoms of the display panel 1200 and the cover panel 1300.

For example, both side surfaces of the display panel 1200 may be supported by the fixing hooks 1151 and the bottom of the display panel 1200 may be supported by the support rib 1154.

Alternatively, the cover panel 1300 may be coupled to the installation panel 1100 while pressing the display panel 1200 toward the installation panel 1100, and the cover panel 1300 may be supported on the support rib 1154. As a result, the cover panel 1300 may be supported by the support rib 1154, so that the loads of the display panel 1200 and the cover panel 1300 may be supported together by the support rib 1154.

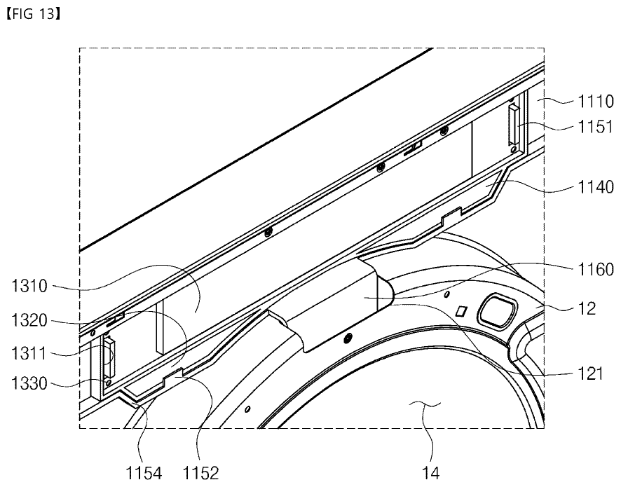

FIG. 13 shows an embodiment of a coupling fixer that couples a cover panel to an installation panel.

The cover panel 1300 may include a panel body 1310 having an area size greater than that of the display panel 1200, and include passage holes 1330 that are formed close to an inner periphery of the panel body 1310, face the respective fastening holes 1153, and allow the respective fastening members to pass therethrough.

The fastening holes 1153 and the passage holes 1330 may be formed outward of the area where the display panel 1200 is installed, so as to be coupled with the fastening members. As a result, while the cover panel 1300 is stably coupled to the installation panel 1100 via the fastening members, the display panel 1200 may be prevented from being interfered with or damaged.

The panel body 1310 may have a height and a width greater than spacings at which the plurality of fixing hooks 1151 are installed. The cover panel 1300 may further include each hook passage hole 1311 through which the fixing hook 1151 may extend through the panel body 1310.

Therefore, the fixing hook 1151 may pass through the cover panel 1300 and support the cover panel 1300 together with the display panel 1200.

In addition, the fixing seating protrusion 1151b of the fixing hook 1151 may be detachably coupled to an outer surface of the hook passage hole 1311 to fix the display panel 1200 together.

The passage holes 1330 may be formed above and below the fixing hooks 1151, and may be formed in the lower support plates. For example, a total of six passage holes 1330 may be formed.

In one example, the coupling fixer 1150 may further include a support hook 1152 that protrudes from the support rib 1154 and is supported on a bottom surface of the cover panel 1300.

The support hook 1152 may serve as a stopper that prevents the cover panel 1300 from deviating rearward.

The support hook 1152 may also serve to fix the cover panel 1300 to the installation panel 1100 by being detachably coupled to a rear surface of the cover panel 1300.

The cover panel 1300 may include an extension body 1130 that extends to face the support plate 1140.

The support hook 1152 may protrude upward from a top surface of the support rib 1154 to support a rear surface of the extension body 1130 or detachably fix the extension body 1130. Accordingly, the coupling fixer 1150 of the installation panel 1100 may stably support and fix the bottom of the display panel 1200 and the bottom of the cover panel 1300 where the stress, the load, and the momentum are concentrated.

In addition, because of the installation panel 1100, the member fixing or coupling the control panel 100 may be prevented from being exposed to the outside of the front panel 11.

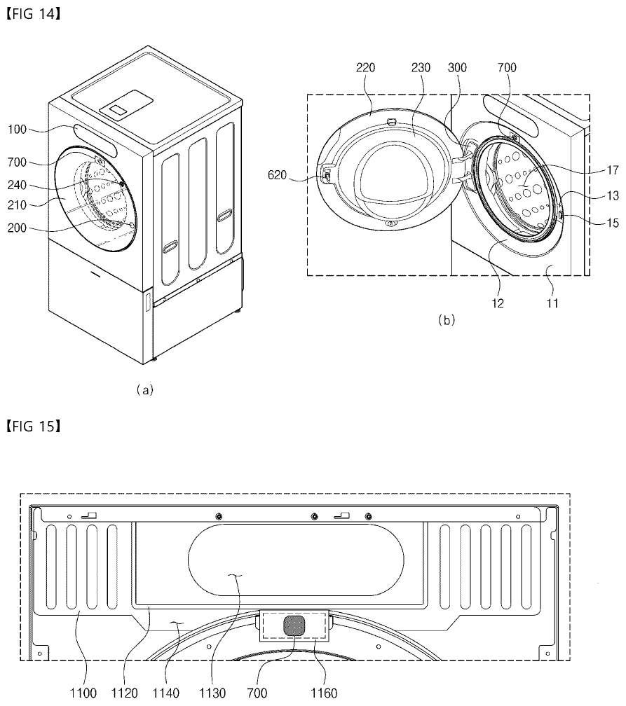

FIG. 14 shows an embodiment in which a laundry treating apparatus of the present disclosure installs a speaker.

Referring to (a) in FIG. 14, the control panel 100 may include the display portion 150 that visually displays the information, and the display portion 150 may be implemented in the display panel 1200.

In addition, the laundry treating apparatus of the present disclosure may further include a speaker 700 that audibly outputs the information.

The speaker 700 may transmit the information in a form of sound to the user who is at a location where the display portion 150 is not able to be checked or who has not recognized the display portion 150.

The speaker 700 may intuitively transmit the pressurization of the power unit 110, the pressurization of the execution unit 120, the pressurization of the course selector 130 and the option selector 140, a warning message, notification information, and the like to the user.

Because the speaker 700 transmits the sound information to the user located in front of or outside of the cabinet 10, it is advantageous to place the speaker 700 facing forward. Accordingly, the speaker 700 of the present disclosure may be disposed to face forward.

In addition, it is important that the sound emitted from the speaker 700 is not blocked by the front panel 11. When the speaker 700 is mounted on the rear surface of the front panel 11, the emitted sound may be blocked by the front panel 11. In this case, an area of the front panel 11 where the speaker 700 is installed should be cut or pierced. However, when the front panel 11 is cut or pierced, the aesthetics may deteriorate, and air or moisture may infiltrate the corresponding area, damaging not only the speaker 700 but also electronic products inside the cabinet 10.

Therefore, the speaker 700 of the present disclosure may be disposed in an area of the front panel 11 that may be shielded by the door 200. As a result, the speaker 700 may be minimized from being exposed to air and moisture outside the cabinet 10, and may also be prevented from being exposed to moisture and air inside the cabinet 10. Therefore, durability of the speaker 700 may be guaranteed.

Furthermore, the speaker 700 of the present disclosure may emit the sound forward of the front panel 11 while being shielded by the door 200. Therefore, the sound generated from the speaker 700 may be effectively transmitted to the user located in front of the cabinet 10.

Referring to (b) in FIG. 14, the door 200 may be coupled to the cabinet 10 via the locker 600, but when an inner glass of the door 200 seals the opening 14, a frame of the door 200 may be spaced apart from the seating portion 12 by a certain spacing.

The speaker 700 may be installed on the seating portion 12. Accordingly, even when the speaker 700 is installed on the front panel 11 and a portion of the front panel 11 where the speaker 700 is installed is cut to expose the speaker 700, the speaker 700 may be prevented from being exposed to moisture or air.

In addition, even when the sound emitted from the speaker 700 collides with the rear surface of the door 200, the sound may be emitted to the outside while passing through a gap between the door 200 and the seating portion 12.

The sound emitted from the speaker 700 may be emitted in all directions while colliding with the rear surface of the door 200 and the seating portion 12. Therefore, an area to which the sound is emitted from the speaker 700 may be wider than when the speaker 700 is directly exposed on the front panel 11.

The speaker 700 may be disposed on an upper portion rather than a lower portion of the seating portion 12.

For example, the speaker 700 may be disposed upward of the hinge 300 or the locker 600. In addition, the speaker 700 may be disposed upward of a rotation center of the drum or the rotation shaft 43 of the driver 40. In addition, the speaker 700 may be disposed upward of a center of the opening 14. As a result, the speaker 700 may be prevented from coming into contact with the laundry entering and exiting the opening 14 and moisture that may leak out of the opening 14.

The speaker 700 may be disposed on an uppermost end of the seating portion 12. As a result, a possibility of exposure to moisture may be minimized while transmitting the sound as far as possible.

In one example, because the speaker 700 may be installed on the seating portion 12 and shielded by the door 200, the speaker 700 may be installed on the front panel 11 but may be disposed forward of the front panel 11.

That is, because the speaker 700 may be shielded by the door 200, there may be no safety problem even when the speaker 700 is exposed forward of the front panel 11. As a result, the sound emitted from the speaker 700 may be emitted to the outside without any restriction or interference of the cabinet 10.

As a result, the user may recognize the sound information more effectively, and may recognize the sound information more clearly when the door 200 is open.

In addition, when the speaker 700 is supplied with the power and the user opens the door 200, it corresponds to a situation in which the user is focused on a state of the laundry treating apparatus, such as having an intention to operate the laundry treating apparatus. In addition, when the door 200 is opened, the sound emitted from the speaker 700 becomes louder than when the door is closed. Therefore, the speaker 700 may be completely exposed to the user on the front panel 11 when the door 200 is open, and may clearly convey the essential sound information to the user.

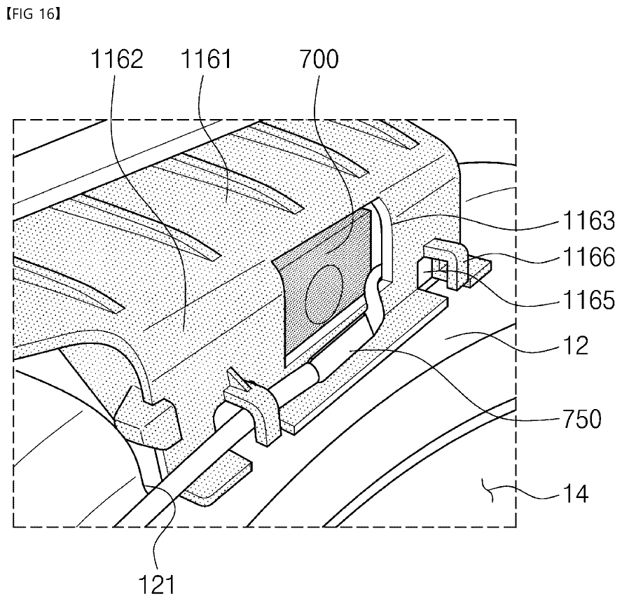

FIG. 15 shows an embodiment in which the speaker is installed on a front panel.

The speaker 700 may be installed on the installation panel 1100.

The bottom surface of the mounting plate 1120 may extend to the seating portion 12 in the installation panel 1100.

Therefore, the installation panel 1100 may include the speaker mounting portion 1160 that is disposed under the mounting plate 1120 and extends to the seating portion 12 for the speaker 700 to be installed.

The speaker mounting portion 1160 may be disposed to overlap the seating portion 12.

The speaker 700 may be installed in a front portion of the speaker mounting portion 1160. As a result, the sound emitted from the speaker 700 may be prevented from being blocked by the installation panel 1100.

As a result, the speaker 700 may be disposed on the front surface of the installation panel 1100, and the control panel 100 may be installed on the rear surface of the installation panel 1100. The installation panel 1100 may provide areas for installing the speaker 700 and the control panel 100 on the front panel 11, and may prevent the speaker 700 and the control panel 100 from interfering with each other.

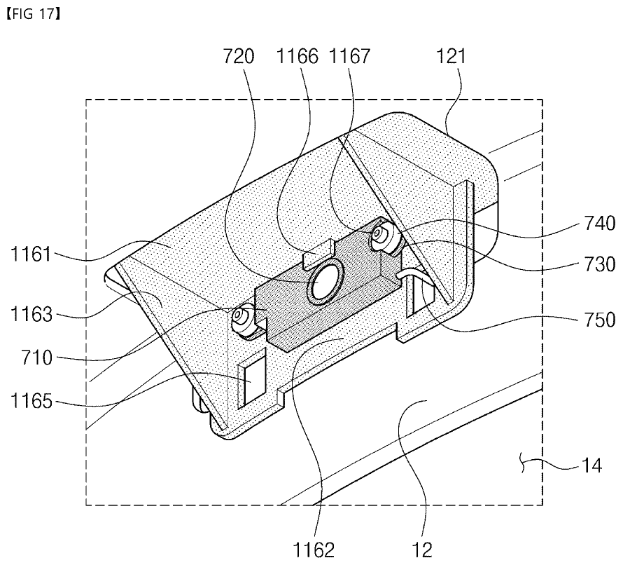

FIG. 16 shows a speaker mounting portion as viewed from the rear of a front panel.

The seating portion 12 is recessed rearward in the front panel 11 to accommodate the door 200 therein. As a result, the rear surface of the seating portion 12 protrudes rearward from the front panel 111 of the front panel 11.

The speaker mounting portion 1160 may be installed on the seating portion 12, and may extend rearward from the mounting plate 1120 to prevent the door 200 and the speaker 700 from colliding with each other.

The speaker mounting portion 1160 may include an extension plate 1161 that is disposed under the mounting plate 1120 and extends rearward, and an exposed plate 1162 that extends downward from the extension plate 1161 to provide an area where the speaker 700 is installed.

The extension plate 1161 may extend rearward from the mounting plate 1120 by a length corresponding to or greater than a height at which the seating portion 12 protrudes rearward from the front surface of the front panel 11 The exposed plate 1162 may extend downward from a distal end or a rear surface of the extension plate 1161 with an area size for the speaker 700 to be installed. As a result, the exposed plate 1162 and the speaker 700 may be prevented from colliding with or interfering with the seating portion 12 or the door 200.

The seating portion 12 may include a cutout 121 that exposes the speaker 700 and the exposed plate 1162 forward. The cutout 121 may be pierced in an area size for the extension plate 1161 and the exposed plate 1162 to pass through the seating portion 12 as they are.

The cutout 121 may be formed as a through-hole extending through an area of the seating portion 12 facing the door 200 in the front plate 111.

The extension plate 1161 may extend from the mounting plate 1120 to the cutout 121, and the exposed plate 1162 may be exposed forward of the seating portion 12 via the cutout 121. As a result, the exposed plate 1162 may be exposed to the front surface of the front panel 11.

The speaker 700 may be mounted on a front surface of the exposed plate 1162. A width of the exposed plate 1162 may be greater than a width in the left and right direction of the speaker 700, and a length by which the exposed plate 1162 extends from the extension plate 1161 may be set greater than a height of the speaker 700.

As the speaker 700 is mounted on the exposed plate 1162, the speaker 700 may be positioned forward of the seating portion 12 and forward of the front panel 11.

The speaker 700 may include a cable 750 that is commanded to generate a sound signal. The cable 750 may pass through the exposed plate 1162 in the speaker 700 and be connected to the control panel 1400 coupled to the installation panel 1100 or the like.

The speaker mounting portion 1160 may include a guide hole 1165 that extends through the exposed plate 1162 and allows the cable 750 to pass therethrough, and may include a fixing ring 1166 that protrudes from the exposed plate 1162 and fixes the cable 750.

The fixing ring 1166 may be formed in any shape as long as it is able to fix the cable 750 and prevent the cable 750 from moving arbitrarily.

In one example, the speaker mounting portion 1160 may include a main through-hole 1163 that exposes the speaker 700 to a rear surface of the exposed plate 1162. The main through-hole 1163 may extend through the exposed plate 1162, but may have an area size smaller than that of the speaker 700.

Via the main through-hole 1163, the worker may easily check an installation location of the speaker 700 at the rear surface of the front panel 11. In addition, the cable 750 of the speaker 700 may pass through the main through-hole 1163.

The speaker mounting portion 1160 may include a lower rib 1167 that protrudes from a lower end of the exposed plate 1162 and supports a lower portion of the cable 750. The cable 750 may be prevented from interfering with the gasket 23, the water supply pipe 52, or the like, via the lower rib 1167.

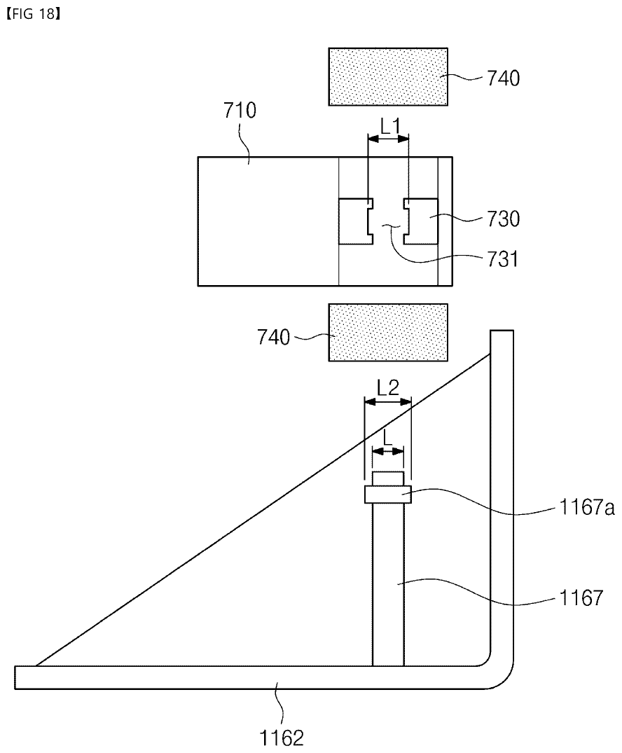

FIG. 17 shows a speaker mounting portion as viewed from the front of a front panel.

The speaker 700 may include a main body 710 that is seated on a front surface of the exposed plate 1162, a sound generator 720 that is accommodated in the main body 710 and receives current to generate sound, and a main body coupling portion 730 that couples the main body 710 to the exposed plate 1162.

The main body 710 may be formed in a casing shape that forms an outer appearance of the speaker 700 and accommodates the sound generator 720 therein, and may be seated on the front surface of the exposed plate 1162. The main body 710 may be disposed forward of the seating portion 12, so that an entire area thereof may be disposed forward of the front panel 11.

The sound generator 720 may receive a signal from the control panel 1400 and vibrate to generate the sound, and may be accommodated in the main body 710, but a portion thereof from which the sound is emitted may be exposed to the front surface of the seating portion 12 via a through-hole formed in the main body 710.

The main body coupling portion 730 may be in any structure as long as it is able to couple the main body 710 to the exposed plate 1162. For example, the main body coupling portion 730 may be formed as a through-hole extending through the main body 710, or may have a coupling hole that extends toward at least one of both sides of the main body 710 and is able to be coupled to the fastening member or the like.

The speaker 700 may include a buffer member 740 coupled to the main body coupling portion 730 to attenuate transmission of the vibration of the cabinet 10 to the main body 710 and the sound generator 720.

The buffer member 740 may block the vibration transmitted from the tub 20 or the cabinet 10 from being transmitted to the main body 710. In addition, the buffer member 740 may also prevent a sound wave generated from the sound generator 720 from being transmitted to the tub 20 and the cabinet 10. Accordingly, even when the speaker 700 is fixed to the front panel 11, the sound generated from the sound generator 720 may be prevented from resonating with other components, and other vibrations or impacts may be prevented from affecting the sound generated from the sound generator 720.

The speaker mounting portion 1160 may further include a reinforcing plate 1163 that connects the exposed plate 1162 with the extension plate 1161 to reinforce durability of the speaker mounting portion 1160. The reinforcing plates 1163 may be disposed on both sides of the main body 710 to block the laundry or foreign substances from approaching side surfaces of the main body 710.

The reinforcing plate 1163 may connect the front surface of the exposed plate 1162 with a bottom surface of the extension plate 1161, and may be disposed in the vertical direction. As a result, the reinforcing plate 1163 may fix shapes and locations of the exposed plate 1162 and the extension plate 1161.

The speaker mounting portion 1160 may include a stopper 1166 that protrudes from the bottom surface of the extension plate 1161 to prevent deviation of the speaker 700.

The stopper 1166 may be disposed on the bottom surface of the extension plate 1161 to be disposed forward of the main body 710. Even when the speaker 700 is separated from the exposed plate 1162, a front surface of the main body 710 may be supported by the stopper 1166, thereby preventing an entirety of the speaker 700 from being separated from the speaker mounting portion 1160.

The guide hole 1165 may be positioned in the exposed plate 1162 between the reinforcing plate 1163 and the main body 710.

The cable 750 may pass through the main body 710 as one end thereof is connected to the sound generator 720, and may be connected to the control panel 1400 by being inserted into the guide hole 1165.

The speaker mounting portion 1160 may include a coupling portion that protrudes from the exposed plate 1162 and fixes the speaker 700. The coupling portion may have any shape as long as it is able to couple the main body coupling portion 730 to the exposed plate 1162. For example, the coupling portion may include a coupling protrusion 1167 that protrudes from the front surface of the exposed plate 1162 and is inserted into a coupling hole 731 of the main body coupling portion 730.

The coupling protrusions 1167 may protrude from the exposed plate 1162 at a spacing at which, when the coupling hole 731 of the main body coupling portion 730 includes a plurality of coupling holes, the respective coupling holes 731 may be coupled thereto.

The buffer member 740 may also be coupled and fixed to the coupling protrusion 1167.

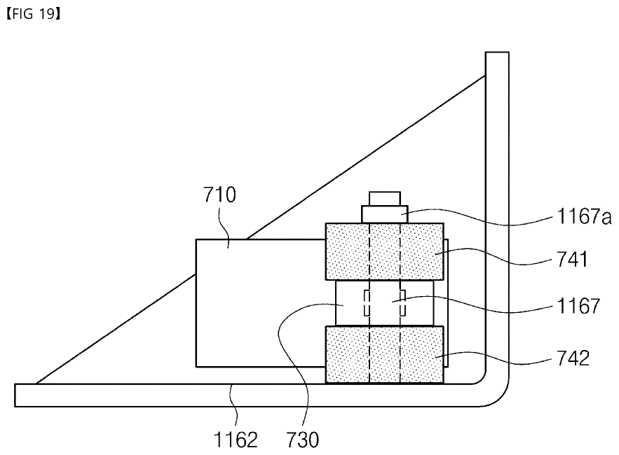

FIG. 18 shows a structural embodiment in which the speaker is coupled to the speaker mounting portion.

A thickness of the main body coupling portion 730 may be smaller than a thickness of the main body 710.

The main body coupling portion 730 may be disposed to be spaced apart from both the rear surface and the front surface of the main body 710, and may have the coupling hole 731 having a width of L1 formed therein.

The buffer member 740 may be disposed on at least one of the rear surface and the front surface of the main body coupling portion 730. The buffer member 740 may be made of an elastic material such as rubber, sponge, and the like.

The buffer member 740 may be disposed between the rear surface of the main body coupling portion 730 and the exposed plate 1162 to buffer vibration or impact transmitted to the main body 710 via the exposed plate 1162. In addition, the buffer member 740 may prevent vibration generated from the sound generator 720 from being transmitted toward the cabinet via the exposed plate 1162.

In addition, the buffer member 740 may be disposed between the front surface of the main body coupling portion 730 and the coupling protrusion 1167 to prevent the main body 710 from arbitrarily vibrating or changing a location thereof on the exposed plate 1162.

A thickness of the buffer member 740 may be greater than a spacing between the rear surface of the main body coupling portion 730 and the exposed plate 1162 or a spacing between the rear surface of the main body coupling portion 730 and the rear surface of the main body 710.

In addition, the thickness of the buffer member 740 may be greater than a spacing between the front surface of the main body coupling portion 730 and a deviation preventing portion 1167a of the coupling protrusion 1167 to be described later or a spacing between the front surface of the main body coupling portion 730 and the front surface of the main body 710.

As a result, the buffer member 740 may fix the location where the speaker 700 is installed in the speaker mounting portion 1160 while buffering the vibration transmitted to the speaker 700.

The coupling protrusion 1167 may protrude by a length at which it may extend from the exposed plate 1162 through the coupling hole 731 and be exposed to the front surface of the seating portion 12.

The coupling protrusion 1167 may be integrally formed with the exposed plate 1162, but may be coupled and fixed to the exposed plate 1162.

A width or a diameter L of the coupling protrusion 1167 may be equal to or smaller than a diameter L1 of the coupling hole 731.

When the coupling protrusion 1167 is inserted into the coupling hole 731, the main body coupling portion 730 may be fixed to the coupling hole 731 in a force-fit method or the like.

The coupling protrusion 1167 may further include the deviation preventing portion 1167a that is disposed forward of the main body coupling portion 730 and has a diameter greater than the diameter L1 of the coupling hole 731.

The deviation preventing portion 1167a may not only prevent the coupling hole 731 from being deviating once the coupling hole 731 is passed through, but also perform a function of pressurizing the buffer member 740 to the main body coupling portion 730.

FIG. 19 shows a cross-section in which a speaker is coupled to a speaker mounting portion.

The buffer member 740 may be fitted with the coupling protrusion 1167 and seated on the exposed plate 1162.

Thereafter, the coupling protrusion 1167 may be fitted into the coupling hole 731 of the main body coupling portion 730 to pressurize the buffer member 740. The buffer member 740 may be reduced in thickness while being pressurized.

However, because of a restoring force of the buffer member 740, the main body 710 may be disposed at least partially spaced apart from the exposed plate 1162. As a result, interference or vibration transmission between the speaker 700 and the speaker mounting portion 1160 may be blocked.

The additional buffer member 740 may be fitted with the coupling protrusion 1167 and disposed on the front surface of the main body coupling portion 730. At this time, as the buffer member 740 is temporarily pressurized to reduce the thickness thereof, a front surface of the buffer member 740 may also be disposed under the deviation preventing portion 1167a. When the external force applied to the buffer member 740 disappears, the buffer member 740 may come into contact with the deviation preventing portion 1167a, but may maintain the state of being pressurized to the deviation preventing portion 1167a.

At this time, when an elastic force to restore the original thickness is generated in a front buffer member 741 disposed on the main body coupling portion 730, the elastic force may press the main body coupling portion 730 to the exposed plate 1162 as much as a reaction force that presses the deviation preventing portion 1167a. Accordingly, the speaker 700 may be more firmly fixed to the speaker mounting portion 1160.

In addition, the elastic force may act as a force that presses a rear buffer member 742 disposed under the main body coupling portion 730. The rear buffer member 742 may be pressed by the transmitted elastic force, but may also have its own restoring force. Therefore, the rear buffer member 742 may generate a restoring force in which one surface pushes the main body coupling portion 730 and the other surface pushes the exposed plate 1162. As a result, a normal force with which the main body 710 is in contact with the exposed plate 1162 may be reduced, or at least a portion of the main body 710 may be spaced apart from the exposed plate 1162. As a result, the speaker 700 and the speaker mounting portion 1160 may be separated from each other from a vibration perspective.

The present disclosure may be modified and implemented in various forms, so that the scope of rights thereof is not limited to the above-described embodiments. Therefore, when the modified embodiment includes elements of the claims of the present disclosure, it should be considered to fall within the scope of the present disclosure.

What is claimed is:

1. A laundry treating apparatus comprising:
a cabinet having an opening formed in a front surface thereof;
a door coupled to the cabinet to open and close the opening;
a tub accommodated in the cabinet to store water therein;
a drum rotatably disposed in the tub to store laundry therein;
a driver coupled to the tub and configured to rotate the drum;
a controller configured to control the driver to perform a course of treating the laundry;
a control panel coupled to the cabinet and configured to receive a command to control the controller; and
a speaker coupled to the cabinet and configured to convert information transmitted from at least one of the controller and the control panel into sound waves,
wherein the speaker is disposed at least partially forward of the cabinet.

2. The laundry treating apparatus of claim 1, wherein the cabinet includes a seating groove extending stepwise from an inner circumferential surface of the opening, wherein the door is seated in the seating groove,
wherein the speaker is disposed at least partially forward of the seating groove.

3. The laundry treating apparatus of claim 2, wherein the speaker is exposed forward from the seating groove to emit the sound waves forward.

4. The laundry treating apparatus of claim 3, wherein the control panel is coupled at a location above the opening,
wherein the speaker is disposed in an area of the seating groove between the control panel and the opening.

5. The laundry treating apparatus of claim 3, wherein the speaker is disposed so as to be at least partially shielded by the door.

6. The laundry treating apparatus of claim 5, wherein the speaker is disposed so as to be prevented from being exposed to the outside when the door closes the opening.

7. The laundry treating apparatus of claim 3,
wherein the cabinet further comprises an installation hole that penetrates the seating groove from above the opening to expose the speaker to the front.

8. The laundry treating apparatus of claim 7, wherein the installation hole has an area size greater than an area size of the speaker.

9. The laundry treating apparatus of claim 8, further comprising a fixer fixing the speaker to the cabinet,
wherein the fixer further includes:
an installation panel coupled to an inner surface of the cabinet at a location above the opening; and
a speaker mounting portion extending from the installation panel to be exposed to the installation hole and fixing the speaker.

10. The laundry treating apparatus of claim 9, wherein the speaker mounting portion includes:
an exposed plate inserted into the installation hole and exposed to the seating groove; and
a guide hole is provided to penetrate the exposed plate to allow a cable connecting the speaker and the control panel or the controller to pass through.

11. The laundry treating apparatus of claim 10, wherein the speaker includes:
a main body seated on the exposed plate;
a sound generator accommodated in the main body and connected to the cable to generate the sound waves;
a main body coupling portion extending from the main body and coupled to the exposed plate; and
a buffer member disposed between the main body coupling portion and the exposed plate to buffer vibration or impact.

12. The laundry treating apparatus of claim 11, wherein the main body is disposed to be spaced apart from the exposed plate.

13. The laundry treating apparatus of claim 11, wherein the speaker mounting portion further includes a coupling protrusion protruding forward from the exposed plate and coupled with the main body coupling portion or the buffer member.

14. The laundry treating apparatus of claim 13, wherein the coupling protrusion includes a deviation preventing portion having a diameter greater than a diameter of a fixing end to prevent deviation of the main body coupling portion or the buffer member.

15. The laundry treating apparatus of claim 1, further comprising a hot air supply portion coupled onto the tub and configured to supply hot air into the drum.
